(19) United States
(12) Patent Application Publication
(10) Pub. No.: US 2026/0246024 A1
(43) Pub. Date: Aug. 20, 2026

(54) INSULATING SEPARATOR FOR AN ELECTRIC BATTERY

(71) Applicant: KEEY AEROGEL, HABSHEIM (FR)

(72) Inventors: Michael O'CONNOR, SCHILTIGHEIM (FR); Kanda PHILIPPE, GALFINGUE (FR); Francisco Manuel RUIZ GONZALEZ, BASEL (CH)

(21) Appl. No.: 19/123,311

(22) PCT Filed: Oct. 26, 2023
(86) PCT No.: PCT/EP2023/080014

§ 371 Date: Apr. 22, 2025

(30) Foreign Application Priority Data
Oct. 27, 2022 (FR) FR2211196

(51) Int. Cl. H01M 10/658; B60L 50/64; H01M 50/204; H01M 50/249; H01M 50/291; H01M 50/293

(52) U.S. Cl. CPC H01M 10/658; B60L 50/64; H01M 50/204; H01M 50/249; H01M 50/291; H01M 50/293; H01M 2220/20

(57) ABSTRACT

A separator suitable for separating two cells of a battery, for example of an electric or hybrid electric vehicle, the separator comprising at least one insulating layer comprising a composite material, the composite material comprising a binder mixed with aerogel particles, the volume content of the aerogel particles in the composite material being greater than 20% and the binder being of the mineral type. The present invention also concerns a battery comprising a separator according to the invention, and a method of manufacturing the separator according to the invention.

The present invention is in the field of electric batteries. More particularly, it concerns a cell separator for an electric battery.

With the advantage of low CO₂ emissions, electric and hybrid electric vehicles are undergoing significant development. These vehicles are fitted with batteries, usually of the lithium-ion type. These batteries can sometimes experience a thermal runaway phenomenon, during which the temperature inside the battery rises spontaneously. The battery can then heat up until it catches fire or explodes. Managing this risk is therefore an important safety issue. One of the challenges is to limit and/or slow the spread of heat and/or fire between adjacent battery cells.

Document WO2006137935 discloses a thermal insulating separator that can be arranged between the cells of a battery. It comprises a fiber-reinforced aerogel encapsulated in a polymer. This solution is very costly, and performs poorly in terms of thermal insulation.

The object of the present invention is to offer an insulating separator with improved thermal insulation, fire resistance and durability.

One object of the present invention is to provide a highly compressible, thermally and electrically insulating separator.

A further object of the present invention is to offer a simple, multi-performance insulating separator that constitutes a single part that is easy to integrate into an existing battery.

The object of the present invention is to respond at least in part to the aforementioned objects by proposing a separator composed mainly of a binder, for mechanical strength, and aerogel, for thermal and fire resistance. To this end, it proposes a separator suitable for separating two cells of a battery, for example of an electric or hybrid electric vehicle, said separator comprising at least one insulating layer comprising a composite material, said composite material comprising a binder mixed with aerogel particles, preferably the content by volume of said aerogel particles (5) in said composite material (4) being greater than 20%, and the sum of the contents by weight of said aerogel particles and said binder in said composite material (4) being greater than 80%; the binder used is a mineral-type binder.

Thanks to these provisions, the rate of heat and/or fire propagation between two battery cells can be reduced, as can the risk of fire spreading outside the battery, or of the battery exploding. In addition, this solution has good durability, as the stresses applied to the battery do not damage the separator; the solution is simple to manufacture. What's more, this type of mineral binder enables pastes to be made with a higher proportion of aerogel. As a result, weight is further reduced, but more importantly, thermal conductivity is reduced, since it is closer to that of aerogel.

According to other features:
said separator may comprise at least one additional layer, said additional layer being, at any square area greater than or equal to 4 cm2 located on one of its external faces, capable of deforming in order to absorb at least part of a reduction in the volume of said separator, thereby preventing wear of battery cells due to cell expansion,
at least one of said at least one additional layer may comprise at least one layer of a ceramic fiber paper, which is a simple and robust means of realizing the invention,
at least one of said at least one additional layer can have a three-dimensional shape on at least one of its faces, for example in the form of a honeycomb, which is a simple solution to implement, and makes it possible to produce a separator with improved durability,
said insulating layer may comprise at least one mechanical reinforcement element, for example in the form of a honeycomb, which ensures that the layer remains in place, for example when the binder tends to crumble,
said binder may comprise a mineral material, for example calcium hydroxide, the volume content of said aerogel particles in said composite material being greater than 90%, the weight content of said mineral material in said binder being greater than 50%, which is a solution for reducing the weight of the separator, and obtaining particularly interesting thermal conductivities,

The present invention also relates to an electric or hybrid electric vehicle battery comprising at least two cells, and at least one insulating separator according to the invention arranged between said cells.

Thanks to these measures, the rate of heat and/or fire propagation between two battery cells can be reduced, as can the risk of fire spreading outside the battery or of the battery exploding. In addition, this solution has a good hold over time, the stresses applied to the battery do not damage the separator ; the separator is easy to manufacture.

Finally, the present invention relates to a process for manufacturing an insulating separator according to one of claims 1 to 5, comprising the following steps:
manufacture of aerogel particles,
aerogel particles are mixed with said binder in a liquid state,
curing the resulting mixture in a mold to obtain said composite material.

Thanks to these arrangements, the separator according to the invention can be produced in a simple way.

According to other features:
the manufacture of said aerogel may comprise the following sub-steps:
   mixing a precursor with a synthesis solvent and a hydrolysis agent such as water, and optionally a catalyst, to obtain a gel,
   granulation of the product obtained by cutting a jet of said gel, to obtain particles,
   This results in less angular particles, which are less brittle and less likely to split,
the manufacture of said aerogel may comprise the following sub-step:
   particle drying, performed entirely at a pressure above the CO₂ critical point.
   which avoids breaking the aerogel particles, and results in a hydrophilic aerogel,
the manufacture of said aerogel may comprise the following sub-steps:
   mixing a precursor with a synthesis solvent and a hydrolysis agent such as water, and optionally a catalyst, to obtain a gel,
   granulation of the resulting product to obtain particles,
   keeping particles in contact with synthesis solvent and hydrolysis agent,
   washing the particles with a washing solvent to extract the hydrolysis agent and, where applicable, the catalyst,
   drying of particles to extract synthesis solvents and/or washing with excess supercritical CO₂,
   the granulation, holding, washing and drying sub-steps are carried out at a pressure above the CO₂ critical point, and these conditions are maintained between these steps, enabling the aerogel to be manufactured continuously; manufacturing times and costs are significantly reduced, and product quality is improved, thanks to a reduction in risky state change and depressurization steps.

The present invention will be better understood on reading the detailed description that follows, with reference to the appended figures in which:

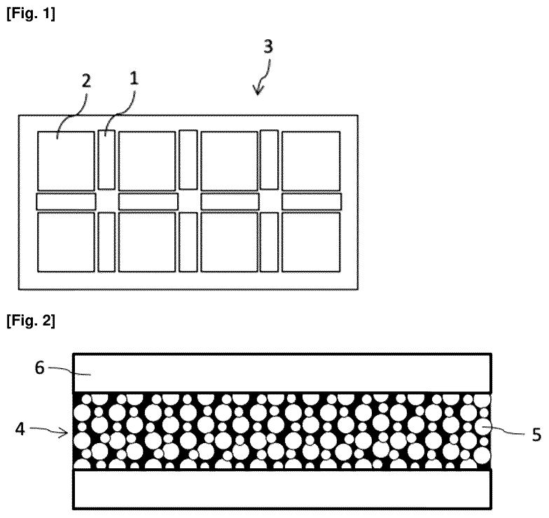

FIG. 1 is a schematic cross-sectional view of a battery incorporating a separator according to the invention.

FIG. 2 is a schematic cross-sectional view of an insulator according to the invention.

The separator 1 according to the invention, shown in a preferred embodiment in FIG. 2, is intended to be integrated between the cells 2 of a battery 3, as shown in FIG. 1.

In a battery 3, the separator 1 can be arranged between all adjacent cells 2, thus achieving maximum efficiency in preventing the spread of heat or fire in the battery. Alternatively, in order to achieve a smaller battery, for example, the separator 1 can be arranged between groups of cells 2, and for example placed every two or three cells 2.

The shape and dimensions of the separator may vary according to the application.

The dimensions of the face of a cell 2 adjacent to the separator are, for example, 200×100 mm, or 300×100 mm. The separator is then preferably in the shape of a rectangular parallelepiped of these dimensions.

The thickness of the separator can be between 2 and 4 mm, for example, making it suitable for a wide range of applications.

The present invention can be applied to any battery, particularly batteries requiring heat management and batteries subject to cell expansion.

The present invention applies in particular to batteries for electric or hybrid electric vehicles. An electric vehicle is a vehicle whose propulsion is ensured exclusively by one or more electric motors, and a hybrid electric vehicle is a vehicle which comprises one or more electric motors capable of ensuring the propulsion of the vehicle, and one or more other types of motors, generally thermal, capable of ensuring the propulsion of the vehicle.

The present invention can also be applied to hydrogen vehicle batteries.

Finally, the present invention can be applied to domestic batteries, used for example to store electricity generated by solar panels.

Battery 3 is preferably a lithium-ion battery. This type of battery is widely used today for its performance in terms of autonomy and its low cost. However, it is also particularly prone to thermal runaway.

The vehicle can be of any type, including a car, truck, van or motorcycle.

The separator according to the invention comprises at least one insulation layer. The insulation layer comprises a composite material 4, comprising a binder mixed with aerogel particles 5.

The binder keeps the aerogel 5 particles optimally distributed within the separator.

The separator 1 preferably complies with the UL 94 V0 standard for flame resistance.

The separator 1 preferably has a thermal resistance that enables it to withstand two minutes with one side at 800° C., and the other side kept below 150° C.

The separator 1 preferably has a thermal and flame resistance that enables it to withstand ten minutes with one side at 1400° C. with the presence of flames, and the other side kept below 300° C.

Aerogel 5 particles are between 0.015 and 3 mm in size.

Aerogel 5 can be a hydrophobic or hydrophilic aerogel.

Preferably, the aerogel is hydrophobic.

Aerogel 5 can be based on any material relevant to this application. It may, for example, be a silica aerogel, a silica-polymer hybrid aerogel, a carbon aerogel, or a mixture of some of these aerogels.

Aerogel 5 is preferably a silica aerogel, which is a very good thermal insulator, with a thermal conductivity, for example, of the order of 0.012 W/m·K. The silica aerogel can, for example, be made from raw materials of which more than 75% by weight are recycled materials from the demolition industry, thereby reducing the manufacturing cost and energy consumption required to manufacture the raw materials.

The binder can be mineral, i.e. it comprises a mineral material whose weight content represents at least 50% of the binder. An example is calcium hydroxide, which has the advantage of being lightweight. In addition, such a binder enables pastes to be made with a higher proportion of aerogel. As a result, the weight is further reduced, but above all the thermal conductivity is reduced, since it is closer to that of aerogel.

In some embodiments, the insulation layer may comprise a reinforcing element, for example in the form of a honeycomb such as the “Nomex Honeycomb” product (registered trademark) marketed by the DuPont company, made from paper covered with phenolic resin. Different types of matrix can be used, in different materials that the skilled person will know how to choose, for example ceramic paper. Such a reinforcing element is particularly interesting when the binder, for example of the mineral type, has a tendency to crumble.

The volume content of aerogel particles 5 in composite material 4 is greater than 20%, giving composite material 4 good thermal insulation.

The binder and aerogel particles 5 make up the majority of the composite material 4, in particular the sum of the weight content of aerogel particles 5 and elastomer in the composite material 4 is greater than 80%, preferably greater than 90%. In addition to the binder and the aerogel particles 5, the composite material 4 may contain various additives, such as a surfactant, to optimize the distribution of the aerogel particles 5 in the composite material 4.

The separator 1 may also include at least one additional layer 6. The volume of the cells 2 of a battery 3, and in particular their thickness, can vary during the charge/discharge cycle. Since the battery pack, comprising the cells 2 and separators 3, has a constant volume, the separators 3 must be able to cope with a reduction in the volume allocated to them. When the volume of the separator 1 is reduced, the additional layer 6 is configured to limit the pressure build-up inside the composite material 4, particularly at the aerogel particles 5 which are at risk of breaking under the effect of high pressure. The additional layer 6 is described in greater detail below.

In particular embodiments, the separator 1 comprises two additional layers, one on each side of the insulation layer.

In other embodiments, the separator 1 comprises an additional layer arranged between two insulation layers.

The additional layer 6 is able to deform in order to absorb a reduction in the volume of the separator 1. In order to achieve efficiency over the entire surface of the separator 1, the additional layer 6 is able to deform at any square area greater than or equal to 4 cm2 located on one of its external faces.

In a preferred embodiment of the invention, the additional layer 6 comprises at least one layer of a ceramic fiber paper. Examples include EST C30 or EST C310, marketed by Morgan Advanced Materials. The ceramic fiber paper can be applied to one side of the insulation layer, e.g. by gluing or laminating, or to both sides, i.e. between the insulation layer and the walls of the cells 2 on either side of the separator 1. This layer of ceramic fiber paper absorbs the reduction in volume caused by the reduction in thickness of the separator 1, and the insulation layer suffers little or no reduction in volume. The ceramic fiber paper layer can be around 1 mm thick.

The additional layer 6 may also comprise at least one layer of an elastomer, for example a silicone elastomer.

The additional layer 6 may also comprise a silicone foam, such as that marketed by Saint-Gobain under the brand name Norseal (registered trademark).

In another embodiment, the additional layer 6 has a three-dimensional shape. Such a layer may be made of an elastomer. This shape then features compression zones; for example, the shape can be a honeycomb shape, and the edges formed by the hexagons constitute the compression zones. These compression zones make it possible to absorb variations in the volume of the separator 1 by deforming part of the separator 1, while the rest of the separator 1 can retain a volume close to its initial volume. For example, the edges of the hexagons widen in a plane perpendicular to the force, so that the thickness of the separator 1 can be reduced without a significant increase in pressure. The additional layer 6 can be directly molded or cast into a shape featuring the compression zones.

The different types of additional layer 6, i.e. ceramic fiber paper, elastomer, silicone foam or three-dimensional shape, can be used individually or in combination.

The separator 1 according to the invention can include a protective envelope, for example in PET, to protect its insulation and volume reduction management layers. This protection is particularly useful when the binder is of the mineral type, which tends to crumble.

The present invention also relates to an electric or hybrid electric vehicle battery 3 comprising at least two cells 2, and at least one insulating separator 1 arranged between said cells 2.

Finally, the present invention relates to a process for manufacturing a separator 1 comprising the following steps:
manufacture of aerogel particles,
mixing the aerogel particles with said binder, e.g. calcium hydroxide. The binder can be dissolved in a solvent,
curing the resulting mixture in a mold to obtain said composite material. A mechanical reinforcement element, such as a honeycomb-shaped structuring matrix, can be added to the mold. Hardening is achieved, for example, by raising the temperature, adding a catalyst or evaporating a solvent.

### EXAMPLE

To prepare a separator according to the invention, 14.19% by weight of calcium hydroxide were mixed with water. Next, 85.8% by weight of hydrophobic silica aerogels, with sieved particle sizes of between 15 and 3000 microns and a density of 70 kg/m3 , and 0.01% by weight of opacifier were added and mixed for 10 min. The result was a homogeneous composition with the consistency of a paste. This paste was spread onto a honeycomb-shaped plate. The paste was left to dry in the plate at a temperature of 35° C. for 10 hours. The result is an insulating separator characterized as follows:
Apparent density of paste after drying: 160 kg/m3
Separator density (paste +plate): 240 kg/m3
Thermal conductivity of paste after drying: 18 mW/m·K at 20° C.
Thermal conductivity of separator (paste+plate): 23 mW/m·K at 20° C.

In Example 1 above, an almost pure calcium hydroxide was used as binder. Alternatively, a commercially available mixture of approximately 30% calcium hydroxide and other minerals can be used as a binder, in which case the binder mass is increased slightly, for example to 25% by mass of such a binder instead of 14.19%.

Depending on the thickness of the separator, in particular between 1 mm and 4 mm, the drying temperature can vary between 20 and 50° C., and the drying time between 4 and 24 hours.

Depending on the type of aerogel used, and in particular its density, which can vary between 50 and 150 kg/m3 , on the binder used—virtually pure calcium hydroxide, or a mixture of mineral materials—and on the plate used, the density of the composite material can vary between 120 and 300 kg/m3 .

Depending on the shape and density of the plate used, whether honeycomb-shaped or not, relatively low aerogel-to-separator volume contents can be achieved, preferably above 20% to take advantage of aerogel's insulating properties; thin, low-mass plates can also be used, to achieve aerogel-to-separator volume contents of over 80%; in some cases over 90% or even 99% by volume, for particularly good results.

The paste obtained can also be left to dry in a mold, thus obtaining a composite material that can be used in a separator according to the invention without the need to add the honeycomb plate. The result is a separator in which the aerogel content can be well over 90% by volume.

Other examples were tested:
7.5% by weight of calcium hydroxide mixed with 92.5% of an aerogel with a density of 50 kg/m3 to produce a paste with a density of 140 kg/m3.
3.7% by weight of calcium hydroxide mixed with 96.3% of an aerogel with a density of 90 kg/m3 to produce a paste with a density of 166 kg/m3.
2% by weight calcium hydroxide mixed with 98% aerogel with a density of 150 kg/m3 to produce a paste with a density of 207 kg/m3 .

The thermal conductivities obtained were similar to those obtained in the above example.

When manufacturing the aerogel particles, the above process may comprise the following sub-steps:
mixing a precursor with a synthesis solvent and a hydrolysis agent such as water, and optionally a catalyst, to obtain a gel,
granulation of the product obtained by cutting a jet of said gel, to obtain particles.

The gel, for example, passes through an opening whose size corresponds to the desired particle size. The jet forming at the outlet of the aperture is then cut at a frequency that also depends on the particle size.

Jet-cut granulation produces aerogel particles with a relatively regular shape and few corners. This reduces the risk the aerogel particles 5 breaking or cracking once they have been integrated into the separator 1, particularly under the effect of stress resulting from the expansion of the cells 2 of the battery 3.

When manufacturing aerogel particles, the process for manufacturing a separator 1 may comprise the following sub-step:
particle drying, performed entirely at a pressure above the CO₂ critical point.

On the one hand, this type of drying avoids deterioration of the particles during drying, and on the other hand ensures that the aerogel particles remain hydrophilic. In fact, other types of drying involving, for example, an evaporation step in ambient air, can result in a loss of the hydrophilic character of the aerogel particles.

Finally, when manufacturing aerogel particles, the process for manufacturing a separator 1 can be a continuous process known to the skilled person and described in document FR1670366. This process comprises the following steps:
mixing a precursor with a synthesis solvent and a hydrolysis agent such as water, and optionally a catalyst, to obtain a gel,
granulation of the resulting product to obtain particles,
keeping particles in contact with synthesis solvent and hydrolysis agent,
washing the particles with a washing solvent to extract the hydrolysis agent and any catalyst,
drying of particles to extract synthesis solvents and/or washing with excess supercritical CO₂,
the granulation, holding, washing and drying sub-steps are operated at a pressure above the CO₂ critical point, and these conditions are maintained between these steps.

Thanks to these provisions, the aerogel manufacturing process can be run continuously, with pressure build-up taking place at a stage when the products are still fluids. As soon as the products are solid (i.e. after granulation), a continuous pressure build-up is no longer possible. Thanks to the invention, the products do not require any pressure build-up once they are solid, nor do they need to be depressurized, apart from the final depressurization. This significantly reduces production time and costs, and improves product quality by reducing the number of risky state change and depressurization steps. In addition, this process enables a drying step to be carried out entirely at a pressure above the CO₂ critical point, without increasing costs.

In this continuous process, the following features can be implemented:
the mixing stage can also be operated at a pressure higher than the critical point of CO₂, enabling this stage to be accelerated slightly,
during the drying step, the solvent-laden particles can be subjected to a jet of supercritical CO₂ so as to place them in fluidized bed conditions, under temperature and pressure conditions such that the CO₂ is supercritical, and the solvent-laden particles are heavier than the CO₂-laden particles, thus enabling the drying step to be carried out continuously, and accelerating the drying step,
the synthesis and/or washing solvent can be an organic solvent and the drying step can be carried out at a pressure of between 100 and 200 bar and a temperature of between 35 and 50° C., ethanol being an inexpensive product suitable for the process, and the conditions between 100 and 200 bars and 35 and 50° C. mean that at certain CO₂ injection rates into the fluidized bed, particles containing ethanol do not fly off, whereas those containing only supercritical CO₂ fly off at the top of the tower, and can be recovered for the rest of the process,
the aerogel manufacturing process can include, after the drying step, a step of replacing the supercritical CO₂ with an inert gas, preferably nitrogen, followed by a decompression step, preferably in stages, this additional step enabling rapid decompression without damaging the aerogel particles,
during the step of replacing the supercritical CO₂ with an inert gas, the particles charged with supercritical CO₂ can be subjected to a jet of said inert gas, so as to bring them into fluidized bed conditions, under temperature and pressure conditions such that the CO₂ is supercritical, and that the charged particles of supercritical CO₂ are heavier than the charged particles of inert gas, enabling the step of replacing supercritical CO₂ with inert gas to be carried out continuously and accelerating this step.

The continuous aerogel particle manufacturing process can be implemented in a plant for manufacturing particulate aerogel from a precursor, comprising:
a mixing reactor,
a granulation device, capable of forming particles from a jet of gelled liquid coming from the mixing reactor, possibly located inside the aging reactor,
an aging reactor,
a washing reactor,
a drying device,
a decompression device.

This installation is special in that the aging reactor, the washing reactor and the drying reactor, as well as the means for transferring products between these reactors, are configured to operate and enable said products to be maintained from one reactor to another at a pressure above the CO₂ critical point.

Thanks to these features, the plant is able to produce aerogel particles continuously, while the pressure can be applied at a stage when the products are still fluids.

The following features can be used in this installation:
the mixing reactor can also be configured to operate and maintain the said products from one reactor to the other at a pressure above the CO₂ critical point; this makes it possible to further reduce the reaction time,
the plant may also comprise a first fluidized-bed tower configured to enable the solvent contained in the particles to be replaced by supercritical CO₂, thereby enabling drying of the particles and accelerating the drying stage,
the plant may also comprise a second fluidized bed tower configured to enable the supercritical CO₂ contained in the particles to be replaced by a pressurized inert gas, preferably nitrogen, enabling rapid decompression to be carried out without damaging the aerogel particles.

Although the above description is based on particular embodiments, it is by no means limitative of the scope of the invention, and modifications may be made, in particular by substitution of technical equivalents or by different combination of all or some of the features developed above.

1. Separator (1) suitable for separating two cells (2) of a battery (3), for example of an electric or hybrid electric vehicle, said separator (1) comprising at least one insulating layer comprising a composite material (4), said composite material (4) comprising a binder mixed with aerogel particles (5), the binder and the aerogel particles (5) representing the major part of the composite material (4), characterized in that the binder is of mineral type, in particular the binder comprises a mineral material whose content by weight represents at least 50% of the binder.

2. Separator (1) according to the preceding claim, wherein the volume content of said aerogel particles (5) in said composite material (4) is greater than 20%.

3. Separator (1) according to one of the preceding claims, wherein the sum of the contents by weight of said aerogel particles (5) and said binder in said composite material (4) is greater than 80%.

4. Separator according to one of the preceding claims, comprising at least one additional layer (6), said additional layer (6) being, at the level of any square zone of an area greater than or equal to 4 cm2 located on one of its external faces, capable of deforming in order to absorb at least part of a reduction in the volume of said separator.

5. Separator according to one of the preceding claims, wherein at least one of said at least one additional layer (6) comprises a ceramic fiber paper.

6. Separator according to one of the preceding claims, wherein at least one of said at least one additional layer (6) has on at least one of its faces a three-dimensional shape, for example in the form of a honeycomb.

7. Separator according to one of the preceding claims, wherein said insulation layer comprises at least one mechanical reinforcement element, for example in the form of a honeycomb.

8. Separator according to one of the preceding claims, wherein said binder comprises at least 30% calcium hydroxide.

9. Separator according to the preceding claim, wherein said binder comprises at least 50%, preferably at least 80% calcium hydroxide.

10. Separator according to one of the preceding claims, wherein the volume content of said aerogel particles (5) in said composite material (4) is greater than 90%.

11. An electric or hybrid electric vehicle battery (3) comprising at least two cells (2), and at least one separator (1) according to one of the preceding claims arranged between said cells (2).

12. Process for manufacturing a separator (1) according to one of claims 1 to 10, comprising the following steps:
manufacture of aerogel particles (5),
mixing the aerogel particles (5) with said binder in a liquid state,
curing the resulting mixture in a mold to obtain said composite material (4).

13. Manufacturing process according to the preceding claim, wherein the manufacture of the aerogel particles (5) comprises the following sub-steps:
mixing a precursor with a synthesis solvent and a hydrolysis agent such as water, and optionally a catalyst, to obtain a gel,
granulation of the product obtained by cutting a jet of said gel, to obtain particles.

14. Manufacturing process according to one of claims 12 to 13, wherein the manufacture of the aerogel particles (5) comprises the following sub-step:
particle drying, performed entirely at a pressure above the CO₂ critical point.

15. Manufacturing process according to the preceding claim, wherein the manufacture of the aerogel particles (5) comprises the following sub-steps:
mixing a precursor with a synthesis solvent and a hydrolysis agent such as water, and optionally a catalyst, to obtain a gel,
granulation of the resulting product to obtain particles,
keeping particles in contact with synthesis solvent and hydrolysis agent,
washing the particles with a washing solvent to extract the hydrolysis agent and any catalyst,
drying of particles to extract synthesis and/or washing solvents with excess supercritical CO2,
the granulation, holding, washing and drying sub-steps are operated at a pressure above the CO₂ critical point, and these conditions are maintained between these steps.
